(19) United States
(12) Patent Application Publication
(10) Pub. No.: US 2009/0314924 A1
(43) Pub. Date: Dec. 24, 2009

(54) PROCESSING MACHINE AND MANUFACTURING METHOD THEREOF

(75) Inventors: Martin SETTELE, Ahlen (DE); Hans-Bernd HUMPE, Beckum (DE)

Correspondence Address: HARNESS, DICKEY & PIERCE, P.L.C., P.O. BOX 828, BLOOMFIELD HILLS, MI, 48303, US

(73) Assignees: Buetfering Schleiftechnik GmbH, Beckum (DE); Homag Holzbearbeitungssysteme Ag, Schopfloch (DE)

(21) Appl. No.: 12/417,734

(22) Filed: Apr. 3, 2009

(30) Foreign Application Priority Data
Jun. 20, 2008 (EP) 08158691.9

(51) Int. Cl. F16M 13/00; B23Q 1/01; B23P 17/04

(52) U.S. Cl. 248/679; 29/527.1

(57) ABSTRACT

The invention concerns a processing machine for the processing of workpieces preferably at least partially made of wood, wooden materials, plastics, metal or the like, comprising at least one load-bearing machine part and at least one processing unit connected to the load-bearing machine part, wherein the load-bearing machine part is made at least in sections from concrete. The inventive processing machine is characterized in that the concrete of the load-bearing machine part is formed by a concrete having a water-binder ratio of at most 0.30 and/or a bending tensile strength of at least 15 MPa.

### FIELD

The invention concerns a processing machine for the processing of workpieces being preferably made at least partly of wood, wooden materials, plastics, metal or the like and having at least one supporting machine part and at least one processing unit connected with the supporting machine part, wherein the supporting machine part is made at least in sections from concrete. Herein, within the framework of the present invention, concrete is to be understood as a minerally bonded, in particular also cementitious concrete.

### BACKGROUND

Processing machines of the above-mentioned type are widely used in the processing and manufacture of workpieces in the furniture and building components industries and a wide variety of other branches of industry. The processing units of these machines are usually built on supporting machine parts traditionally made from steel or steel plates. The increasing processing speeds and the dynamic forces of the processing machines associated therewith lead to a continuous increase in the importance of the oscillation behavior of the supporting machine parts.

Against this background it has been proposed to produce a machine bed, which is an essential load-bearing (supporting) machine part, of mineral casting, that is a mixture of a synthetic binder and additives (see for example DE 20 2006 019 323 U1). The synthetic binders necessary for it are, however, laborious to process and associated with high costs.

As alternative thereto machine beds consisting entirely or partially of concrete have recently been used, too. For instance, DE 37 34 895 A1 discloses a concrete frame for internal cylindrical grinding machines having a concrete bed configured as a dual double-T-beam in cross-section. It turned out, however, that the known concrete frame warps due to time dependent shrinkage deformations so that dimensional inaccuracies develop which are undesirable in the precise (surface grinding) processing of workpieces. Even the concrete-cast steel frames mentioned in DE 37 34 895 A1 will not change anything about this disadvantage, the more so as these steel frames result in a complicated structure of the concrete frame.

### SUMMARY

Therefore, it is an object of the present invention to provide a processing machine of the generic type, which has a simple structure with low dimensional deviations and is cheap to produce.

According to the invention, this object is achieved by means of a processing machine according to claim 1 and a method of production of a processing machine according to claim 8. Particularly preferred embodiments of the invention are defined in the dependent claims. The invention is based upon the notion to configure the load-bearing (supporting) machine parts, which are made at least in sections from concrete, so as to largely eliminate shrinkage deformations without thereby developing reactive forces which have to be compensated for by means of laborious structures. Against this background the invention envisions that, in a processing machine of the generic type, the concrete of the load-bearing machine parts is formed by a concrete having a water-binder ratio of at most 0.30.

In this way it is ensured that upon setting and hardening of the concrete almost the entire amount of water of the concrete is set (bound) within a relatively short time already so that the water contained in the concrete is largely removed as the main cause of the shrinkage. This results in the base body of the surface grinding device of the invention having only very low shrinkage deformations at an early stage after the production of the base body so that no distortion phenomena or other dimensional deviations result at all. It is to be observed that this result in order to achieve, no additional mounting or urging devices such as steel frames or the like are necessary.

It turned out in the process that the tendency of shrinkage of the concrete could again be disproportionately reduced if, according to a further embodiment of the invention, the concrete of the supporting machine part has a water-binder ratio of at most 0.25, preferably at most 0.20.

To achieve the above-mentioned advantages, it is envisioned alternatively or in addition to the water-binder ratio of the invention that the concrete of the load-bearing machine part has a bending tensile strength of at least 15 MPa. Thereby, completely new design possibilities for load-bearing machine parts result. For example, thanks to the concrete composition of a further embodiment of the invention, also the utilization of rod-shaped reinforcement inserts such as reinforcing steel bars or the like can be renounced. Herein, “bar-shaped reinforcement inserts” are to be understood as such reinforcements that give a countable contribution to the static and/or dynamic load capacity of the machine part. A so called “constructive reinforcement” or auxiliary reinforcement for transport purposes, localized load application etc. does not fall thereunder. By renouncing reinforcement inserts, the structure of the base body is further simplified and an extremely high design freedom in results for the base body.

This is particularly true if, according to a further embodiment of the invention, the concrete has a bending tensile strength of at least 20 MPa, preferably at least 25 MPa. To ensure a high strength and durability of the load-bearing component at the same time, it is envisioned according to a further embodiment of the invention that the concrete of the load-bearing components comprises fibers, in particular metal fibers and/or synthetic fibers. It is to be observed that, within the framework of the present invention, fibers from a wide variety of materials may be utilized.

It is particularly preferred that the concrete of the load-bearing component has a compressive strength of at least 90 MPa, preferably at least 120 MPa, more preferably at least 150 MPa. Thus, the load-bearing machine part is suitable also for heavy-duty processing operations.

The load-bearing machine part may, within the framework of the present invention, concern a wide variety of machine parts of a processing machine of the generic type, wherein in many cases it may also be a dynamically loaded machine part. In some applications, the machine part's inventive configuration in concrete may be suitable also for casing parts or the like. According to a further embodiment of the invention, it is envisioned, however, that the load-bearing machine part forms a machine part chosen from the group consisting of machine bed, support (mount), cantilever arm, gentry beam, console, base support and housing. The inventors have realized that the inventive configuration of these machine parts from a special concrete allows for the above-mentioned advantages to be particularly pronounced, that is to say to provide machine parts having a simple structure, low dimensional deviations and high durability at low prices.

A particularly advantageous method of production of a processing machine according to the invention is defined in claim 8. It is characterized in that the load-bearing (supporting) machine part is heat treated after casting the concrete and is joined with a processing unit only subsequently. Firstly, the heat treatment of the concrete makes it possible that the shrinkage behavior of the hardened concrete is further improved so that the dimensional accuracy and durability of the machine part is optimized accordingly. Moreover, also the strength of the concrete can be increased. Last but not least, due to the heat treatment the time necessary for the production of the machine part can be shortened, bringing about not only advantages in terms of time but also reducing the number of necessary formwork moulds and other auxiliary means.

According to a further embodiment of the inventive method it is envisioned that the heat treatment is preformed such that the degree of shrinkage (shrinkage value) of the concrete after the heat treatment is at least 90%, preferably at least 95% of the final degree of shrinkage (final shrinkage value) according to DIN 1045-1. Thereby, it becomes possible for the shrinkage of the concrete to be largely concluded after the heat treatment so that only negligible shrinkage deformations occur after joining the load-bearing machine part to a processing unit. Hereby, concrete as a material advances into regions of dimensional accuracy hitherto reserved only to metal supports.

In order to achieve a particularly effective and, at the same time, gentle heat treatment of the concrete, a further embodiment of the invention envisions that the heat treatment is preformed at a temperature in the range of 70° C. to 120° C., preferably in region of 80° C. to 100° C. Thereby, a particularly effective improvement of the shrinkage behavior ensues without inducing undesirable crack formation or defect formation in the concrete.

Moreover, according to a further embodiment of the invention, it turned out to be advantageous to perform the heat treatment for a duration of at least 24 hours and preferably of at least 36 hours. Thereby, not only a rapid production process ensues, but also a gentle and effective improvement of the shrinkage behavior as well as an increase in load capacity.

### DRAWINGS

FIG. 1 schematically shows a perspective view of a processing machine as a first preferred embodiment of the present invention;

FIG. 2 schematically shows a perspective view of a processing machine as a second preferred embodiment of the present invention.

### DETAILED DESCRIPTION

In the following, preferred embodiments of the invention will be described in detail by reference to the accompanying drawings.

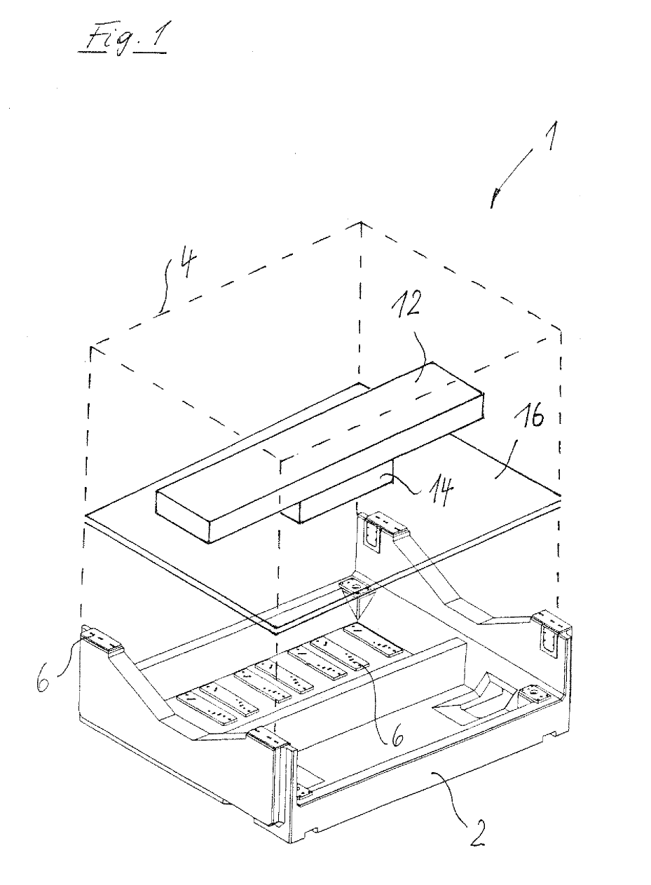

A processing machine 1 as first preferred embodiment is schematically shown in FIG. 1 in a perspective view. In the present embodiment, the processing machine 1 is a surface grinding machine for the processing of workpieces made from a wide variety of materials such as wood, wooden materials, plastics, metal or the like. To that end, the processing machine 1 comprises a processing unit 14 which in FIG. 1 is shown purely schematically. The processing unit 14 may, for example, be a circumferential endless grinding means or other suitable grinding devices.

Moreover, it is to be observed that within the framework of the present invention neither the type of processing nor the type of the workpiece to be processed is limited. The processing machine may, for example, be also a drilling or milling machine, an edge banding (gluing) machine, a laser processing machine or a processing center combining these and other processing operations. Moreover, it may be a stationary machine as shown in FIG. 1, for instance, but may also be a throughfeed machine in which the workpieces are conveyed on a suitable conveyer means in a conveying direction and are processed in the course of the conveying operation.

In the present embodiment, a workpiece holder 16, which is configured to hold or convey the workpieces to be processed (not shown) during processing, is arranged below the processing unit 14. In the present embodiment, the workpiece holder 16 may also be a conveyer belt that conveys a workpiece beneath the processing unit 14.

In the present embodiment, the processing unit 14 is mounted to a support 12 which thus serves as load-bearing (supporting) machine part for the processing unit 14. The support 12 is made of concrete, the properties of which will be described in more detail in the following.

The support 12 is connected through a housing 4, shown in broken lines, to a machine bed 2 which is, in the present embodiment, also made of concrete. Even though the concrete of the machine bed 2 and of the support 12 may have different properties, in the present embodiment they are designed, in principle, with the same properties, as described in the following.

The concrete is a minerally bonded, in particular also a cementitious concrete, that is not, for example, a so called “polymeric concrete”. The concrete is, thus, substantially free of polymeric binders, although the concrete may also comprise various synthetic additives, for example to improve its flow characteristics upon casting.

The inventive peculiarity of the concrete is that it has a low water-binder ratio of at most 0.30 and a high bending tensile strength of at least 15 MPa. The water-binder ratio is defined as the ratio between the mass of the effective water content (kg) and the mass of the associated binder content (kg). The bending tensile strength may be determined within the framework of a four-point bending experiment on prismatic test bodies, for example by means of the four-point bending test defined in the guidelines of the German Concrete Association (Deutscher Betonverein).

In the present embodiment, the concrete may concretely have a water-binder ratio of about 0.18 and a bending tensile strength of about 30 MPa. A further essential material parameter of the concrete is its compressive (burst) strength which, in the present embodiment, is at lest 150 MPa, wherein the compressive strength of the concrete is defined as the measurement value of the compressive strength according to DIN 1045-1.

A contribution for achieving these values of strength is that the concrete comprises, in the present embodiment, fibers such as metal fibers, synthetic fibers or other suitable fibers. Thereby, not only the strength values of the concrete are increased, but the concrete is also less susceptible to cracks, has an improved shrinkage behavior and an increased durability. Moreover, providing fibers in the concrete contributes to reduce the necessity of bar-shaped reinforcement inserts such as ribbed reinforcing steel bars in the load-bearing machine parts so that, according to the application and the characteristics of the concrete, it is in many cases possible to renounce such reinforcement inserts completely. In these cases, however, constructive reinforcements may be present, for example to protect the load-bearing machine parts during transport or to provide local load application points.

By way of the exceptional properties of the concrete utilized it becomes possible in the invention to produce a wide variety of load-bearing (and possibly non-load-bearing) machine parts from concrete, such as for example the machine bed shown in FIG. 1 or the support shown in FIG. 1, but also other components such as gantry beams, consoles, base supports, casing parts or the like, even though these are not shown in the figures.

The production and processing of the concrete discussed here, in particular of the fiber concrete, is in principle known in the art and thus to the skilled person, and in principle corresponds to the approach used in the field of construction (structural engineering). Thus, the production of the fiber concrete may, for example, be performed according to the guidelines of the Deutscher Ausschuβ für Stahlbeton (German Commission for Reinforced Concretes) bearing the title “Stahlfaserbeton” (Fiber-reinforced Concrete) (21^{st} draft of April 2005). With respect to the production and processing of concrete one may equally resort to the publication of the Association Français de Genie Civile bearing the title “Interim Recommendations on Ultra-High Performance Fiber-Reinforced Concrete” (2002).

Considering these known basics, the production of the processing machine shown in FIG. 1 may take place as follows. First, fresh concrete is produced, which has the above-described water binder ratio and is configured in its composition to have a bending tensile strength of 25 MPa when hardened. Then, the concrete is cast into a suitable formwork for the machine bed 2 or the support 12 and possibly densified.

Thereafter, the concrete is subjected to a heat treatment in a device not shown by storing it at a temperature in a range of 80° C. to 100° C. for 24 to 36 hours. In the course of this heat treatment, the concrete rapidly hardens, with the water contained in the fresh concrete setting almost completely with the binders or even evaporating to some extent. In this way, the shrinkage of the concrete after the heat treatment is already largely terminated.

Thereupon, the load-bearing machine part may be taken out of the formwork already and be joined directly or indirectly with the machine parts as well as with at least one processing unit 14 at a desired point in time in order to form a processing machine 1.

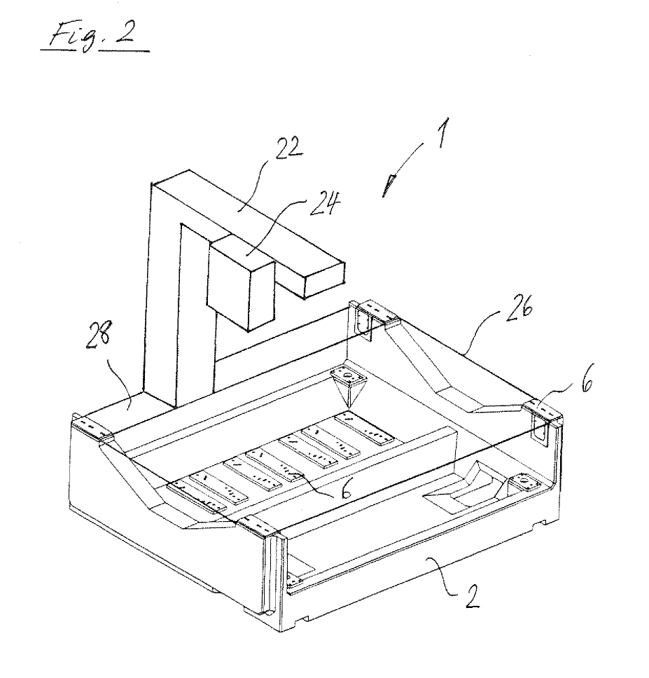

A further processing machine 1 according to a second preferred embodiment of the invention is schematically shown in FIG. 2 in a perspective view. The embodiment shown in FIG. 2 differs from the first embodiment in that, firstly, it is not a grinding machine but a processing center. Thus, the processing machine shown in FIG. 2 comprises a processing table 26 arranged upon the base body 2, for example in form of a known console table which may also be made of or with concrete parts.

Further, a guide 28 is arranged on the base body 2, upon which a cantilever arm 22 is arranged in way so that the cantilever arm 22 is translatable along the guide 28. On the cantilever arm 22 a processing unit 24 is arranged in such a way that the processing unit 24 is translatable along the cantilever arm 22. The processing unit may, for example, be a processing mandrel in which various processing tools or processing aggregates may be substituted according to need. In this way, workpieces arranged on the processing table 26 may be processed by means of the processing unit 24 in a wide variety of manners.

Apart from the machine bed 2 also the cantilever arm 22 is, in the present embodiment, made of concrete, wherein the concrete has the same properties as in the above-mentioned first embodiment. In this way, in both embodiments a novel processing machine can be obtained which has low dimensional deviations with a simple and cheap production and which allows processing operations of very high dynamics.

Regarding the load-bearing machine parts 2, 12 and 22 made of concrete according to the above embodiments, it is to be observed that these are shown as concrete parts made in one piece. It is to be observed, however, that the load-bearing machine parts made of concrete may also be configured in several parts and that they may be hybrid components, that is components in which the concrete body is joined with other components such as steel girders or the like. Hereby, several concrete components and/or other parts may be glued together. Equally, the load-bearing machine parts made of concrete may have various mounting and anchoring points which are made of steel, for example, and are set into the concrete. Examples thereof are the anchoring points 6 shown in FIGS. 1 and 2, to which the casing 4, the machine table 26 or other components may be attached.

1. A processing machine for the processing of workpieces made at least partially of wood, wooden materials, plastics, metal or the like, comprising:
at least one load-bearing machine part and at least one processing unit connected with the load-bearing machine part, wherein the load-bearing machine part is made at least in sections from concrete, wherein:
the concrete of the load-bearing machine part is formed by a concrete having at least one of a water binder ratio of at most 0.30 and a bending tensile strength of at least 15 MPa.

2. The processing machine of claim 1, wherein the concrete of the load-bearing machine part has a water binder ratio of at most 0.25.

3. The processing machine of claim 1, wherein the concrete of the load-bearing machine part has a bending tensile strength of at least 20 MPa.

4. The processing machine of claim 1, wherein the concrete of the load-bearing machine part may be free of bar-shaped reinforcement inserts.

5. The processing machine of claim 1, wherein the concrete of the load-bearing machine part comprises fibers.

6. The processing machine of claim 1, wherein the concrete of the load-bearing machine part has a compressive strength of at least 90 MPa.

7. The processing machine of claim 1, wherein the load-bearing machine part forms a machine part chosen from the group consisting of machine bed, support cantilevers, gantry beam, console, base support and casing.

8. A method of production of a processing machine according to claim 1, comprising the following steps:
producing a load-bearing machine part from concrete having a water-binder ratio of at most 0.30,
heat treating the concrete, and
joining the load-bearing machine part with a processing unit.

9. The method of claim 8, wherein the degree of shrinkage of the concrete after the heat treatment is at least 90% of the final degree of shrinkage according to DIN 1045-1.

10. The method of claim 8 or 9, wherein the step of heat treating is performed at a temperature in the range of 70 to 120° C.

11. The method of claims 8 or 9, wherein the step of heat treating is preformed for a period of at least 24 hours.

12. The processing machine of claim 1, wherein the concrete of the load-bearing machine part has a water binder ratio of at most 0.20.

13. The processing machine of claim 1, wherein the concrete of the load-bearing machine part has a bending tensile strength of at least 25 MPa.

14. The processing machine of claim 1, wherein the fibers are selected from the group consisting of metal fibers and/or synthetic fibers.

15. The processing machine of claim 1, wherein the concrete of the load-bearing machine part has a compressive strength of at least 120 MPa.

16. The processing machine of claim 1, wherein the concrete of the load-bearing machine part has a compressive strength of at least 150 MPa.

17. The method of production of a processing machine according to claim 8 wherein the load-bearing machine part formed from concrete has a water-binder ratio of at most 0.25.

18. The method of claim 8, wherein the degree of shrinkage of the concrete after the heat treatment is at least 95% of the final degree of shrinkage according to DIN 1045-1.
